(19) United States
(12) Patent Application Publication
(10) Pub. No.: US 2013/0152384 A1
(43) Pub. Date: Jun. 20, 2013

(54) APPLICATOR OF A ROLLED STRIP

(71) Applicant: Hsiu-Man YU CHEN, Taichung City (TW)

(72) Inventor: Hsiu-Man YU CHEN, Taichung City (TW)

(21) Appl. No.: 13/330,930

(22) Filed: Dec. 20, 2011

(51) Int. Cl. B23P 19/00

(52) U.S. Cl. 29/700

(57) ABSTRACT

An applicator of a rolled strip includes a grip, a lining and a pivotal tube. The grip is made of flexible material, formed tubular with a sealed bottom and an open top. The lining is inserted in the grip, formed tubular with two open ends. The lining has plural axial slots. The pivotal tube has one end inserted in the lining and another end inserted in an axial hole of a rolled strip. The pivotal tube can pivotally turn in the lining if not interfered by any foreign force. When a user holding the grip gives a radial force, the pivotal tube is to be squeezed by the lining to stop rotating, so that the user can adjust wrapping tightness of the rolled strip.

### BACKGROUND OF THE INVENTION

1. Field of the Invention

This invention relates to an applicator of a rolled strip.

2. Description of the Prior Art

Commonly, in order to keep goods from shaking to fall down while being delivered, a wrapping material, such as plastic film, is used to wrap up such goods, carried out by an applicator. For users' convenience, the wrapping material is usually formed as a roll. FIG. 1 shows a conventional film applicator, invented by the present inventor as well, able to adjust packing tightness of the wrapping material. The conventional film applicator includes a base body 1 formed cylindrical, a restricting groove 2 recessed in the center of the base body 1, a grip portion 3 positioned at one side of the restricting groove 2, and an applying portion 4 positioned at another side of the restricting groove 2 for inserting in a central hole of a rolled film 5. Mounted around the restricting groove 2 is a restricting member 6, which is composed of two semi-annular parts. A braking sleeve 7 is fixed outside the restricting groove 2 and the grip portion 3, employed to timely give a radial force to a braking strip 8 inside it to still the base body 1, so as to keep the rolled film 5 from rotating and let a user properly adjust wrapping tightness to achieve an effective wrapping tension.

Although the conventional film applicator can timely adjust wrapping tightness of a rolled film 5, it has a complicated structure, with a base body 1 recessed with a restricting groove 2 mounted with a restricting member 6 to enable the base body 1 to pivotally whirl in it.

### SUMMARY OF THE INVENTION

The object of this invention is to offer an applicator of a rolled strip, with a low cost, provided with a simple structure and convenient operation. In operation, a rolled strip can be easily ceased unreeling for a user to adjust tightness of the strip to pack goods effectively.

The main characteristics of the invention are a grip, a lining and a pivotal tube. The grip is made of flexible material, formed tubular with a sealed bottom and an open top. Formed in an inner wall of a top of the grip are two grooves. The lining is inserted in the grip, formed tubular with two open ends. The lining is provided with two projections to correspondingly engage with the grooves of the grip, plural slots cut axially and at least an annular projection formed in an inner wall. The pivotal tube has one end inserted in an axial hole of a rolled strip and another end inserted in the lining, provided with an annular groove to correspondingly engage with the annular projection of the lining. The pivotal tube has an outer diameter slightly smaller than the inner diameter of the lining.

A user can hold the grip to enable the pivotal tube to rotate so as to wrap up goods with the rolled strip. With a radial force given by a user to make the lining compact the pivotal tube, the pivotal tube and the rolled strip can be stopped rotating to let the user to adjust packing tightness of the strip. So the invention has a simple structure and can be operated conveniently.

### BRIEF DESCRIPTION OF DRAWINGS

This invention is better understood by referring to the accompanying drawings, wherein:

FIG. 1 is a cross-sectional view of a conventional film applicator;

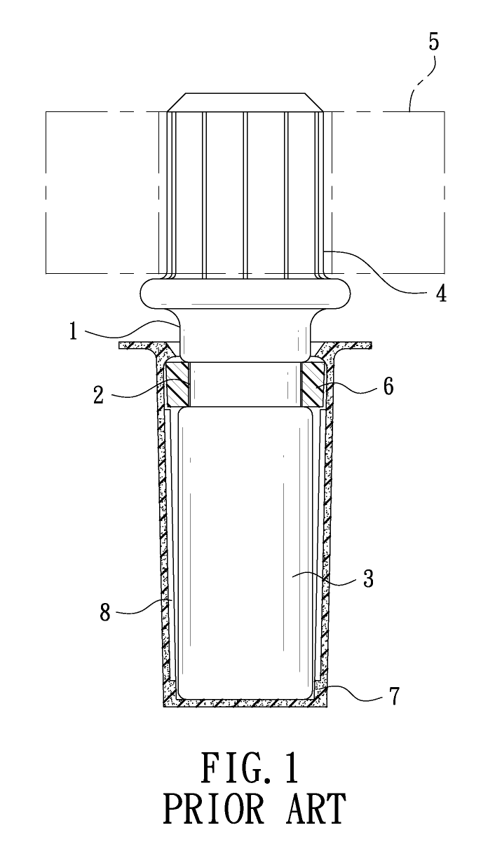

FIG. 2 is an exploded perspective view of a preferred embodiment of an applicator of a rolled strip in the present invention;

FIG. 3 is an axial cross-sectional view of a grip in the preferred embodiment of an applicator of a rolled strip in the present invention;

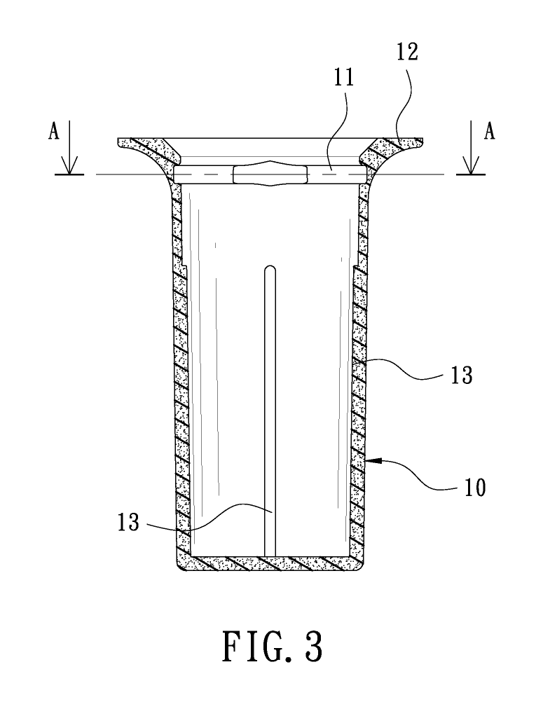

FIG. 4 is a cross-sectional view of the ‘A-A’ line in FIG. 3;

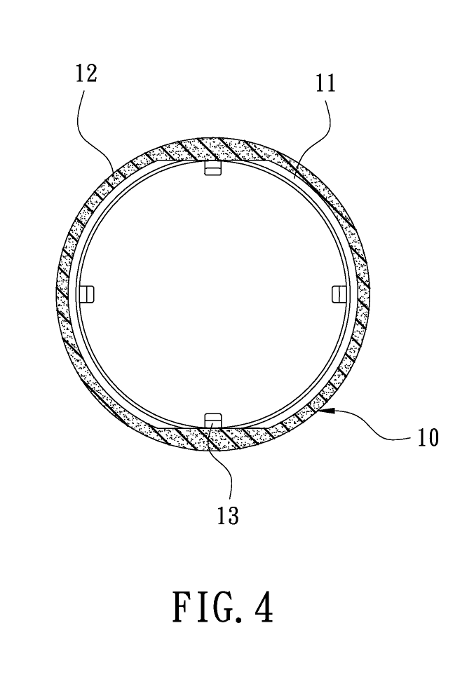

FIG. 5 is an axial cross-sectional view of a lining in the preferred embodiment of an applicator of a rolled strip in the present invention;

FIG. 6 is a top view of the lining in the preferred embodiment of an applicator of a rolled strip in the present invention;

FIG. 7 is a cross-sectional view of the preferred embodiment of an applicator of a rolled strip in the present invention, showing it is running normally; and

FIG. 8 is a cross-sectional view of the preferred embodiment of an applicator of a rolled strip in the present invention, showing it is temporarily ceased while working.

### DETAILED DESCRIPTION OF THE PREFERRED EMBODIMENT

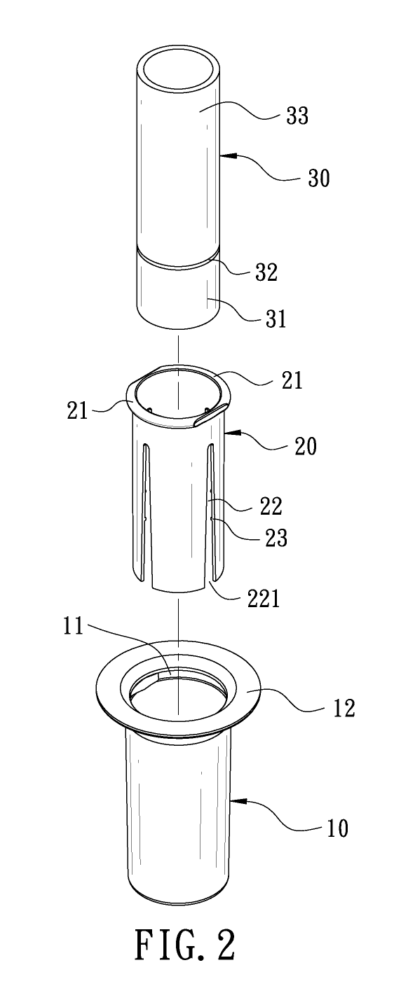

As shown in FIG. 2, a preferred embodiment of an applicator of a rolled strip in the present invention includes a grip 10, a lining 20 and a pivotal tube 30.

With reference to FIGS. 2˜4, the grip 10 is made of flexible material, formed tubular with a sealed bottom and an open top. The grip 10 is provided with a first positioning member 11 formed in an inner wall of the open end, a flange 12 horizontally extended outward from the top, and plural ribs 13 axially projected from the interior wall and spaced apart equidistantly. In the embodiment, the first positioning member 11 has two grooves.

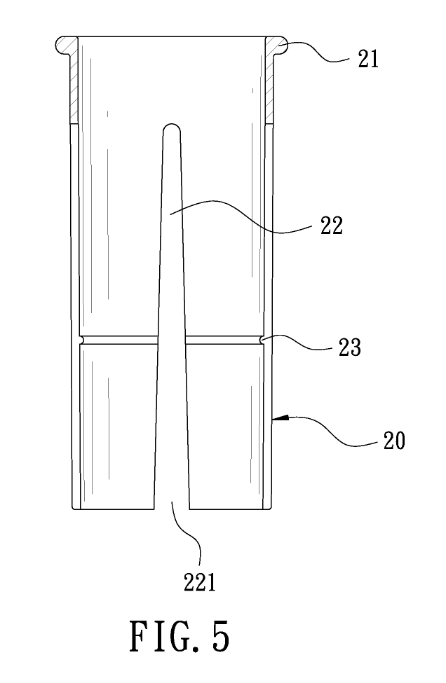

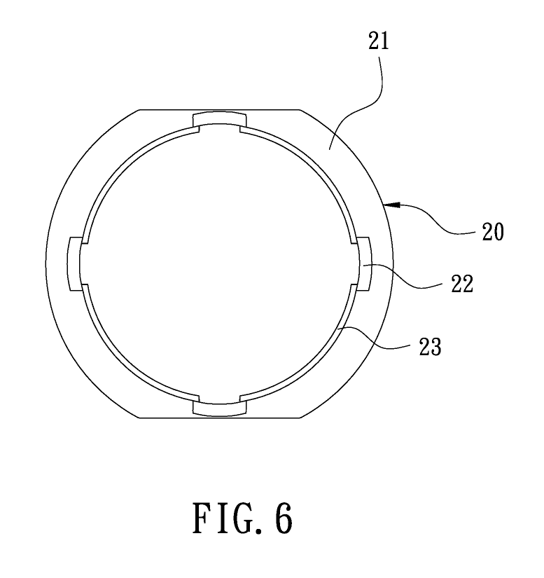

As shown in FIGS. 2, 5 and 6, the lining 20 is formed tubular with two open ends, inserted in the grip 10. The lining 20 is provided with a second positioning member 21 formed on the outer wall to fit with the first positioning member 11, plural slots 22 cut axially to correspond to the ribs 13, and a first restricting member 23 projected around the inner wall. In the embodiment, the second positioning member 21 is shaped as two semi-circular projections employed to make the grip 10 fixedly engaged with the lining 20; each of the slots 22 has a free bottom end 221, and the first restricting member 23 is an annular projection.

As shown in FIG. 2, the pivotal tube 30 has one end formed as a grip portion 31, a second restricting member 32 formed in the inner wall to correspond to the first restricting member 23 of the lining 20, and another end formed as a working portion 33 to plug in a rolled strip. In the embodiment, the second restricting member is an annular groove used to lock with the first restricting member 23; each of the slots 22 has a free bottom end 221. And the pivotal tube 30 has an outer diameter slightly smaller than the inner diameter of the lining 20 so that the pivotal tube 30 can turn in the lining 20.

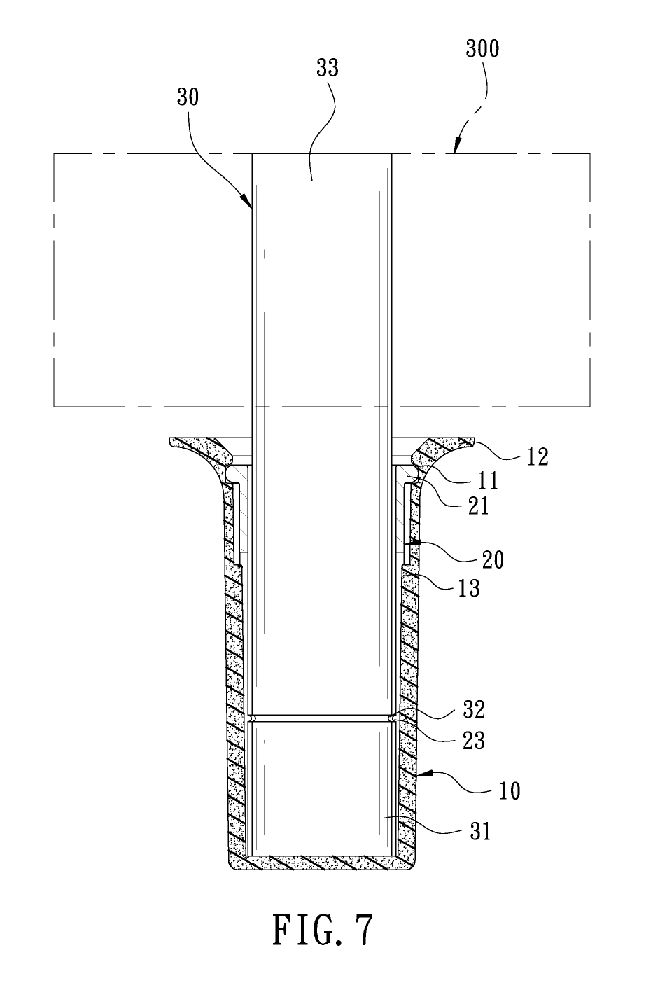

For assembly, as shown in FIG. 7, the bottom end of the lining 20 is first inserted into the grip 10 from the open end, with the first positioning member 11 locked with the second positioning member 21 and with the ribs 13 engaged with the slots 22 so that the lining 20 can be restrictively combined with grip 10. Next, the grip portion 31 of the pivotal tube 30 is inserted into the top end of the lining 20, with the second restricting member 32 engaged with the first restricting member 23. By the time, the pivotal tube 30 can rotate in the lining 20 as the outer diameter of the pivotal tube 30 is slightly smaller than the inner diameter of the lining 20, and the assembly of the applicator of a rolled strip is thus finished.

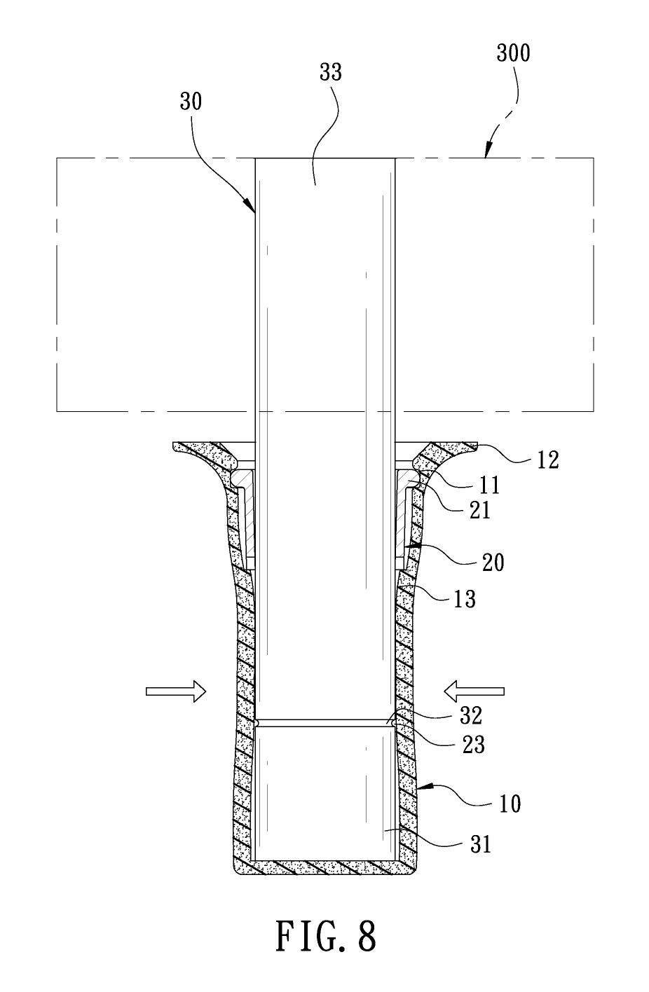

In using, the working portion 33 of the pivotal tube 30 is first inserted in an axial hole of a rolled strip 300, so that the rolled strip 300 can work together with pivotal tube 30. If the rolled strip 300 is to be unreeled, a user can hold the grip 10 to wrap goods in a desired direction. With the rotation of the pivotal tube 30, the rolled strip 300 can be smoothly released. In FIG. 8, when a radial force is timely given by the grip 10, the grip 10 is to be deformed to squeeze the lining 20 to shrink its inner diameter, so as to enable the ribs 13 to contact on the outer wall of the pivotal tube 30 to cease it from rotating. So the rolled strip 300 is steadily stopped as well. By the time, the user can keep giving radial force to adjust packing tightness of the rolled strip 300. The rolled strip 300 can be unreeled again while the grip 10 is turned backward to release the radial force. Therefore, the rolled strip 300 can wrap up goods with sufficient tension by just commanding the grip 10.

While the preferred embodiment of the invention has been described above, it will be recognized and understood that various modifications may be made therein and the appended claims are intended to cover all such modifications that may fall within the spirit and scope of the invention.

What is claimed is:

1. An applicator of a rolled strip comprising:
a grip made of flexible material and formed tubular with a sealed bottom and an open top, a first positioning member formed in an inner wall of said top end of said grip;
a lining formed tubular with two open ends and inserted in said grip, said lining provided with a second positioning member formed on an outer wall to correspondingly engage with said first positioning member, plural slots cut axially in said lining, a first restricting member projected around an inner wall of said lining;
a pivotal tube having one end inserted in an axial hole of a rolled strip and another end inserted in said lining and provided with a second restricting member formed in an inner wall to correspond to said first restricting member of said lining, said pivotal tube having an outer diameter slightly smaller than an inner diameter of said lining so that said pivotal tube can turn in said lining; and
said pivotal tube able to pivotally whirl in said lining if not interfered by any foreign force and able to be squeezed by said lining to stop rotating due to a radial force given by a user holding said grip.

2. The applicator of a rolled strip as claimed in claim 1, wherein said first positioning member is formed as two semi-circular grooves.

3. The applicator of a rolled strip as claimed in claim 1, wherein said second positioning member is formed as two semi-circular projections.

4. The applicator of a rolled strip as claimed in claim 1, wherein said first restricting member is an annular projection.

5. The applicator of a rolled strip as claimed in claim 1, wherein said second restricting member is an annular groove.

6. The applicator of a rolled strip as claimed in claim 1, wherein said grip is provided with plural ribs formed axially on an inner wall to correspondingly fit in said slots of said lining.

7. The applicator of a rolled strip as claimed in claim 1, wherein said grip is provided with a flange horizontally extended outward from a top.

8. The applicator of a rolled strip as claimed in claim 1, wherein each of said slots has a bottom end formed as an open free end.
